(19) United States
(12) Patent Application Publication
(10) Pub. No.: US 2008/0280052 A1
(43) Pub. Date: Nov. 13, 2008

(54) Process for Printing Textile Fibre Materials in Accordance with the Ink-Jet Printing Process

(76) Inventor: Roger Lacroix, Village-Neuf (FR)

Correspondence Address: JoAnn Villamizar;Ciba Corporation/Patent Department, 540 White Plains Road, P.O. Box 2005, Tarrytown, NY, 10591, US

(21) Appl. No.: 10/574,719

(22) PCT Filed: Oct. 6, 2004
(86) PCT No.: PCT/EP04/52450

§ 371 Date: Apr. 5, 2006

(30) Foreign Application Priority Data
Oct. 15, 2003 (EP) 03103808.6

(51) Int. Cl. B05D 1/02; C09D 11/02

(52) U.S. Cl. 427/421.1; 106/31.52; 106/31.51; 106/31.49; 106/31.44; 106/31.5

(57) ABSTRACT

An ink-jet printing process for printing textile fibre materials, wherein
the fiber materials are printed with an aqueous ink comprising
(I) at least one anionic acid dye, and
(II) dipropylene glycol,
said ink having a viscosity of from 5 to 20 mPa s at 25° C., and wherein
the said ink is applied to the fiber material with an ink-jet print head comprising
an ink supply layer (b) receiving ink from an external ink reservoir, said ink supply layer having a first side and a second side and comprising, a porous medium having a plurality of pores therein and a plurality of holes extending therethrough, so as to allow passage of the ink allows for high speed printing and yields prints with good fastness properties.

The present invention relates to a process for printing textile fibre materials using anionic acid dyes in accordance with the ink-jet printing process and to corresponding printing inks.

Rotary and flat-screen printing are presently prevailing as textile printing methods. However, these conventional methods are not profitable unless the quantity of the product is sufficiently large. In addition, since the fashion of the print pattern changes rapidly, there is a risk in that a large quantity of the printed products are not sold but kept in stock when production cannot follow the rapid change in the fashion. Accordingly, there is a demand for establishing electronic textile printing systems, such as ink-jet, that require no printing plates and are suited for multi-item and small-quantity production and respond to fashion rapidly.

Ink-jet printing technology opens up new design capabilities around colors, patterns and images. The ability to change colors and designs quickly is one of the major advantages of ink-jet printing over rotary traditional screen-printing methods. In a digital system, design changes are enabled through software, without needing to engrave screens. Color changes are also made at the computer, eliminating the process of cleaning screens and changing inks. Actual fabric samples of new designs are possible at a fraction of the cost and in a fraction of the time formerly needed. By this way designers and textile and apparel companies can interact to bring new products to market almost instantaneously. Instantaneous data transfer over the global Internet and similar data exchange via local area networks (LANs) make it possible to exchange ideas faster than ever.

Despite the many advantages, ink-jet still suffers from some drawbacks, some of which become even more pronounced when print speed is increasing. Hardware reliability (e.g. clogged nozzles) and speed limitations are technical barriers limiting the use of ink-jet printing primarily to generation of samples. State of the art ink-jet textile printers are capable of printing 2 to 30 m²/h operating at a frequency of 2 to 8 KHz. In order to become a true production method both for short runs and for sampling, ink-jet processes are required which are reliable even at high print speed (e.g. >200 m²/h). However, when printing at high speed, the response to high frequency is liable to be impaired and the ink tends to be unstable depending on the physical property of the ink, owing to the fact that the ink has to be discharged through minute nozzles at high velocity and at high frequency. Furthermore, the quality of the print tends to be impaired due to blotting on the cloth, partly because the ink jet printer does not allow the use of an ink having high viscosity and partly because cloth usually has rougher texture than paper, thus making it difficult to print patterns of minute or delicate design.

Accordingly there is a need for ink-jet printing processes which can be conducted with high reliability, even when running at a high print speed, with an appreciable resolution and which have optimum characteristics from the standpoint of application technology. In this connection the properties of the inks used, such as the viscosity, stability, surface-tension and conductivity, play a decisive role. Furthermore, high demands are being made in terms of the quality of the resulting prints, e.g. in respect of colour strength, fibre-dye bond stability and fastness to wetting. Those demands are not met by the known processes in all characteristics, so that there is still a need for new processes for the ink-jet printing of textiles.

The invention relates to an ink-jet printing process for printing textile fibre materials, wherein

the fiber materials are printed with an aqueous ink comprising
(I) at least one anionic acid dye, and
(II) dipropylene glycol,
said ink having a viscosity of from 5 to 20 mPa s at 25° C., and wherein
said ink is applied to the fiber material with an ink-jet print head comprising
an ink supply layer (b) receiving ink from an external ink reservoir, said ink supply layer having a first side and a second side and comprising, a porous medium having a plurality of pores therein and a plurality of holes extending therethrough, so as to allow passage of the ink.

The dyes used in the inks should preferably have a low salt content, that is to say they should have a total content of salts of less than 0.5% by weight, based on the weight of the dyes. Dyes that have relatively high salt contents as a result of their preparation and/or as a result of the subsequent addition of diluents can be desalted, for example, by membrane separation procedures, such as ultrafiltration, reverse osmosis or dialysis.

The inks preferably have a total content of dyes of from 0.1 to 35% by weight, preferably from 0.1 to 30% by weight, especially from 0.1 to 20% by weight and more especially from 0.1 to 15% by weight based on the total weight of the ink. As a lower limit, a limit of 0.5% by weight, especially 1% by weight, is preferred.

Suitable acid dyes for the process according to the invention include, for example, the dyes described under “Acid Dyes” in the Colour Index, 3rd edition (3rd revision 1987 inclusive Additions and Amendments up to No. 85). The anionic dyes that can be used may belong to a wide variety of dye classes and may contain one or more sulfonic acid groups. They include, for example, triphenylmethane dyes having at least two sulfonic acid groups, heavy-metal-free monoazo and disazo dyes each having one or more sulfonic acid groups, and heavy-metal-containing, namely copper-, chromium-, nickel- or cobalt-containing, monoazo, disazo, azomethine and formazan dyes, especially metallised dyes, that contain two molecules of azo dye, or one molecule of azo dye and one molecule of azomethine dye, bonded to a metal atom, especially such dyes containing mono- and/or dis-azo dyes and/or azomethine dyes as ligands and a chromium or cobalt ion as central atom, as well as anthraquinone dyes, especially 1-amino-4-arylaminoanthraquinone-2-sulfonic acids and 1,4-diarylamino- or 1-cycloalkylamino-4-arylaminoanthraquinonesulfonic acids.

There come into consideration as anionic acid dyes, for example:

a) triphenylmethane dyes of formula

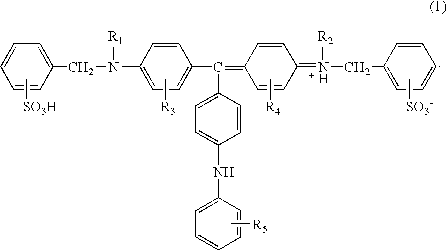

wherein
R₁, R₂, R₃ and R₄ are each independently of the others C₁-C₄alkyl, and
R₅ is C₁-C₄alkyl, C₁-C₄alkoxy or hydrogen;
b) monoazo and disazo dyes of formulae

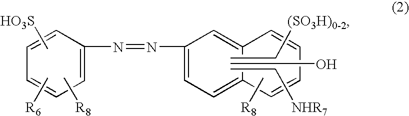

wherein
R⁶ is benzoylamino, phenoxy, chlorophenoxy, dichlorophenoxy or methylphenoxy,
R₇ is hydrogen, benzoyl, phenyl or C₁-C₄alkyl, and
the substituents R₈ are each independently of the other hydrogen, phenylamino or N-phenyl-N-methylaminosulfonyl;

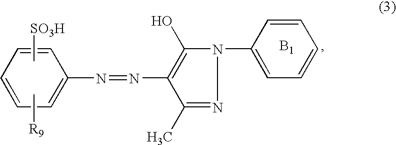

wherein
the phenyl ring B₁ may be substituted by at least one substituent selected from the group halogen, C₁-C₄alkyl and sulfo, and
R₉ is α-bromoacryloylamino;

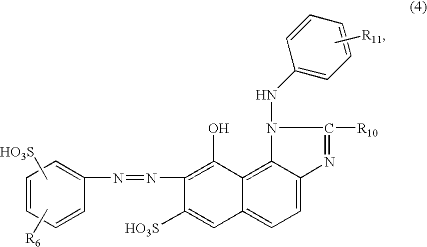

wherein
R₆ has the meanings given above,
R₁₀ is C₁-C₈alkyl, and
R₁₁ is halogen; and

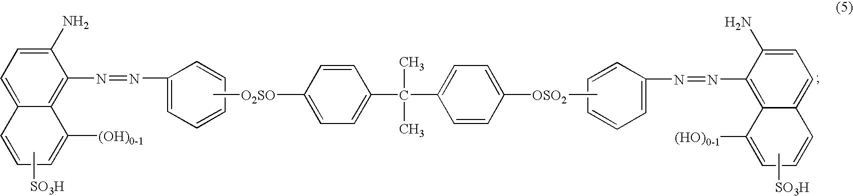

c) 1:2 metal complex dyes, such as 1:2 chromium complex dyes of azo and azomethine dyes of formulae

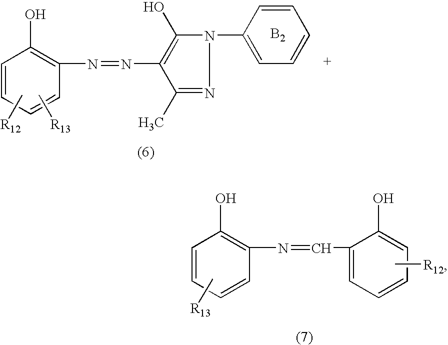

wherein
R₁₂ is hydrogen, sulfo or phenylazo,
R₁₃ is hydrogen or nitro, and
the phenyl ring B₂ may be substituted by at least one substituent selected from the group halogen, C₁-C₄alkyl and sulfo;
d) 1:2 metal complex dyes, such as asymmetric (mixed) or symmetric 1:2 chromium complex dyes, preferably symmetric 1:2 chromium complex dyes, of azo dyes of formulae

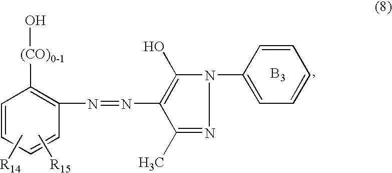

wherein
the phenyl ring B₃ may be substituted by at least one substituent selected from the group halogen, C₁-C₄alkyl and sulfo, and
R₁₄ and R₁₅ are each independently of the other hydrogen, nitro, sulfo, halogen, C₁-C₄alkylsulfonyl, C₁-C₄alkylaminosulfonyl or —SO₂NH₂; and

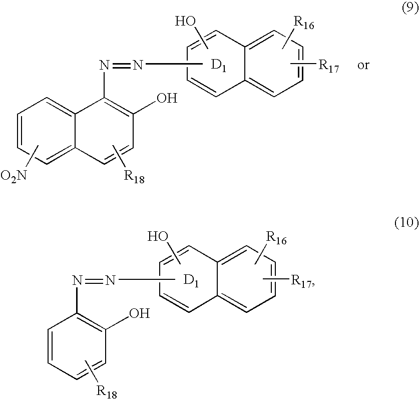

wherein
R₁₆ is hydrogen, C₁-C₄alkoxycarbonylamino, benzoylamino, C₁-C₄alkylsulfonylamino, phenyl-sulfonylamino, methylphenylsulfonylamino or halogen,
R₁₇ is hydrogen or halogen, and
R₁₈ is C₁-C₄alkylsulfonyl, C₁-C₄alkylaminosulfonyl, phenylazo, sulfo or —SO₂NH₂,
the hydroxy group in the benzo ring D₁ being bound in the o-position relative to the azo group on the benzo ring D₁;
symmetric 1:2 cobalt complexes of the azo dyes of formulae

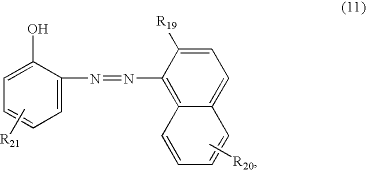

wherein
R₁₉ is an —OH or —NH₂ group,
R₂₀ is hydrogen or C₁-C₄alkylaminosulfonyl, and
R₂₁ is nitro or C₁-C₄alkoxy-C₁-C₄alkyleneaminosulfonyl, and

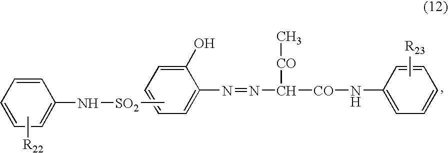

wherein
R₂₂ is carboxy or sulfo, and
R₂₃ is halogen;
asymmetric 1:2 chromium complex dyes of the azo dyes of formulae

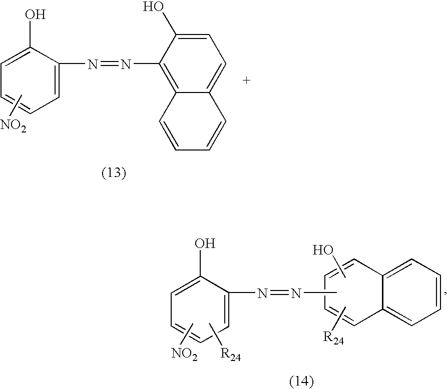

wherein
one substituent R₂₄ is hydrogen and the other is sulfo;

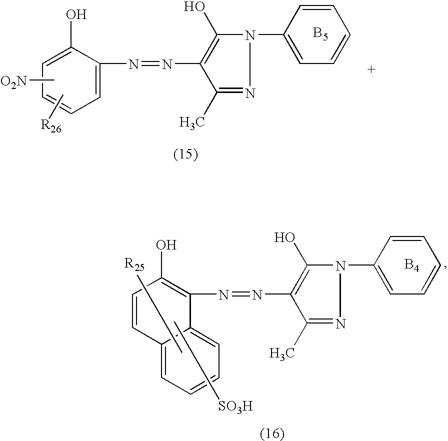

wherein
R₂₅ is hydrogen or nitro, the phenyl rings B₄ and B₅ each independently of the other may be substituted by at least one substituent selected from the group halogen, C₁-C₄alkyl and sulfo, and
R₂₆ is hydrogen or halogen; and

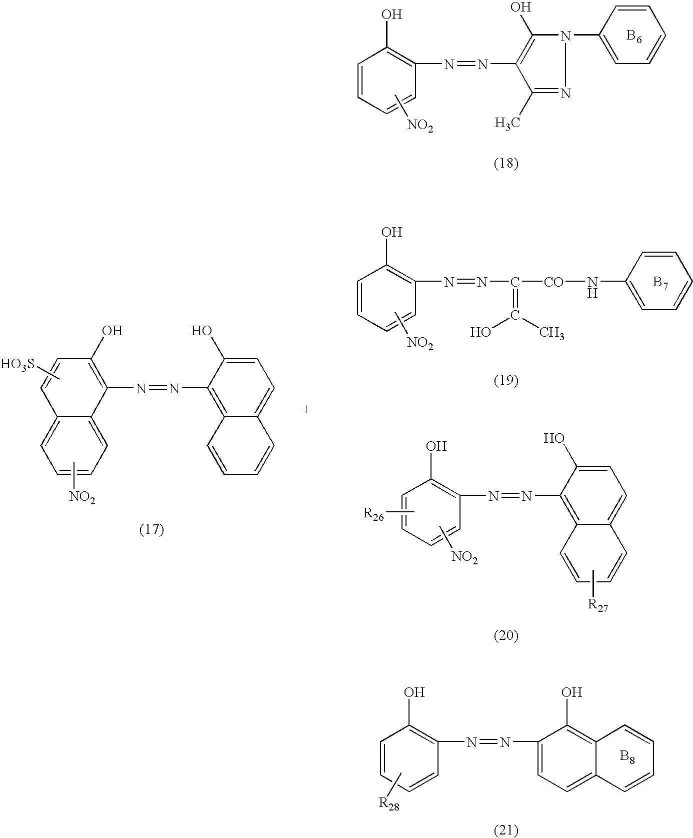

wherein
the phenyl rings B₆, B₇ and B₈ each independently of the other may in each case be substituted by at least one substituent selected from the group halogen, C₁-C₄alkyl and sulfo,
R₂₆ is hydrogen or nitro,
R₂₇ is hydrogen, methoxycarbonylamino or acetylamino, and
R₂₈ is C₁-C₄alkylsulfonyl, C₁-C₄alkylamino-sulfonyl, phenylazo, sulfo or —SO₂NH₂;
the copper complex of formula

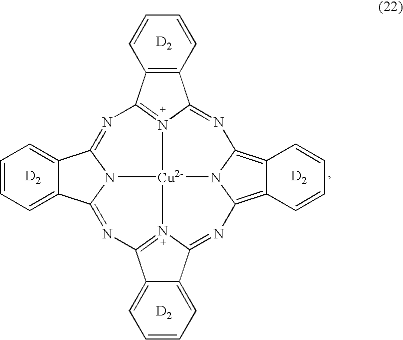

wherein
the benzo rings D₂ are substituted by sulfo or sulfonamido;
e) anthraquinone dyes of formulae

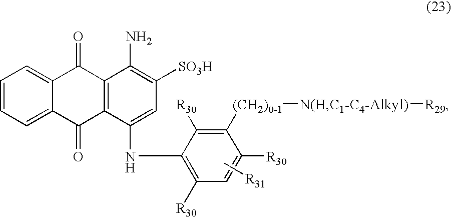

wherein
R₂₉ is α-bromoacryloylamino,
the substituents R₃₀ are each independently of the others hydrogen or C₁₋₄alkyl, and
R₃₁ is hydrogen or sulfo;

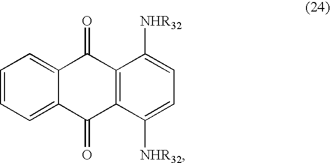

wherein
the substituents R₃₂ are each independently of the other cyclohexyl or a diphenyl ether radical that may be substituted by sulfo or by the radical —CH₂—NH—R₂₉ in which R₂₉ has the meanings given above; and

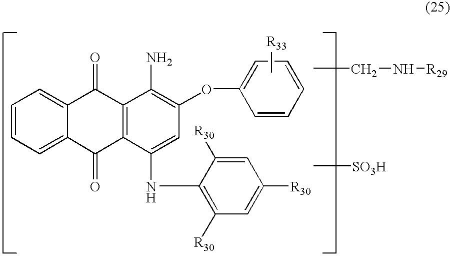

wherein
R₂₉ is α-bromoacryloylamino,
R₃₀ has the meanings given for formula (23), and
R₃₃ is C₄-C₈alkyl;
f) metal-free anionic anthraquinone dyes of formulae

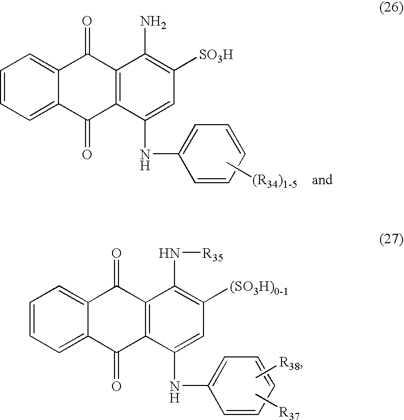

wherein
(R₃₄)₁₋₅ denotes from 1 to 5 identical or different substituents selected from the group C₁-C₄-alkyl unsubstituted or substituted by C₂-C₄alkanoylamino (which may in turn be substituted in the alkyl group by halogen) or by benzoylamino; C₁-C₄alkoxy; C₂-C₄alkanoylamino and C₂-C₄hydroxyalkylsulfamoyl;
R₃₅ is C₁-C₄alkyl, C₅-C₇cycloalkyl unsubstituted or substituted by C₁-C₄alkyl, or phenyl unsubstituted or substituted by phenoxy, C₁-C₄alkyl or by sulfo, the phenoxy group in turn being unsubstituted or substituted in the phenyl ring by C₁-C₄alkyl, C₁-C₄alkoxy, halogen or by sulfo, especially by C₁-C₄alkyl or by sulfo;
R₃₈ and R₃₇ are each independently of the other sulfo, C₁-C₄alkyl unsubstituted or substituted by C₂-C₄alkanoylamino (which may in turn be substituted in the alkyl group by halogen) or phenoxy unsubstituted or substituted in the phenyl ring by C₁-C₄alkyl, C₁-C₄alkoxy, halogen or by sulfo, especially by C₁-C₄alkyl or by sulfo; and
g) monoazo dyes of formulae

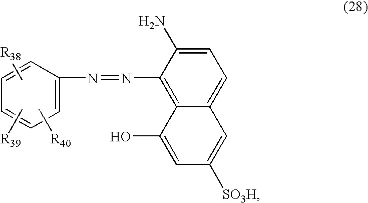

wherein
R₃₈ is halogen, phenylsulfonyl, trifluoromethyl or

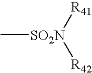

in which R₄₁ is cyclohexyl and R₄₂ is C₁-C₄alkyl, or the radicals R₄₁ and R₄₂, together with the nitrogen atom linking them, form an azepinyl ring;
R₃₉ is hydrogen or halogen,
and R₄₀ is hydrogen or is phenoxy unsubstituted or substituted in the phenyl ring by halogen;

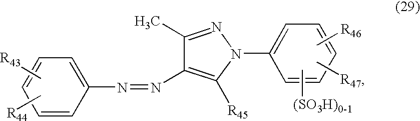

wherein
R₄₃ is hydrogen, halogen or sulfo;
R₄₄ is hydrogen; halogen; phenoxy or phenoxysulfonyl unsubstituted or substituted in the phenyl ring by C₁-C₄alkyl, C₁-C₄alkoxy or by halogen; a radical of formula

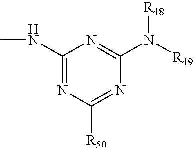

in which R₄₈ is phenyl unsubstituted or substituted by C₁-C₄alkyl, C₁-C₄alkoxy, halogen or by sulfo, R₄₉ is hydrogen or C₁-C₄alkyl and R₅₀ is halogen; or a radical of formula

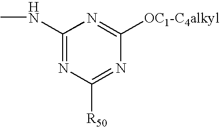

in which R₅₀ is as defined above;
R₄₅ is hydroxy or amino; and
R₄₆ and R₄₇ are each independently of the other hydrogen, C₁-C₄alkyl or halogen;

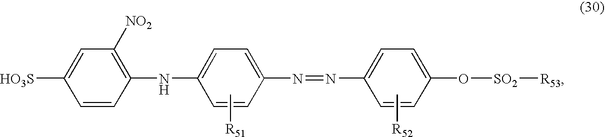

wherein
R₅₁ and R₅₂ are each independently of the other hydrogen, C₁-C₄alkyl, C₁-C₄alkoxy, halogen or C₂-C₄alkanoylamino, preferably hydrogen or C₁-C₄alkyl,
R₅₃ is phenyl unsubstituted or substituted by C₁-C₄alkyl, C₁-C₄alkoxy, halogen or by C₂-C₄-alkanoylamino, preferably unsubstituted phenyl or phenyl substituted by C₁-C₄alkyl;

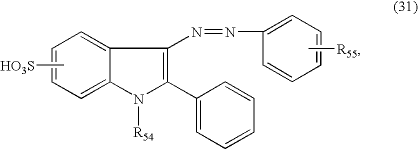

wherein
R₅₄ is hydrogen or C₁-C₄alkyl,
R₅₅ is hydrogen or phenylsulfonyl unsubstituted or substituted in the phenyl ring by C₁-C₄alkyl, C₁-C₄alkoxy, halogen or by C₂-C₄alkanoylamino, preferably unsubstituted phenylsulfonyl;

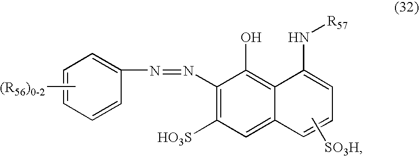

wherein
(R₅₆)₀₋₂ denotes from 0 to 2 identical or different substituents selected from the group C₁-C₄-alkyl, C₁-C₄alkoxy, halogen and phenoxy unsubstituted or substituted in the phenyl ring by C₁-C₆alkyl, C₁-C₄alkoxy, sulfo, halogen or by C₂-C₄alkanoylamino, preferably unsubstituted phenoxy or phenoxy substituted by C₁-C₆alkyl or by halogen, and
R₅₇ is benzoyl unsubstituted or substituted in the phenyl ring by C₁-C₄alkyl, C₁-C₄alkoxy, sulfo or by halogen, preferably unsubstituted benzoyl, C₂-C₄alkanoyl unsubstituted or substituted in the alkyl group by hydroxy or by C₁-C₄alkoxy, preferably unsubstituted C₂-C₄alkanoyl, e.g. acetyl, phenylsulfonyl or methylphenylsulfonyl; and

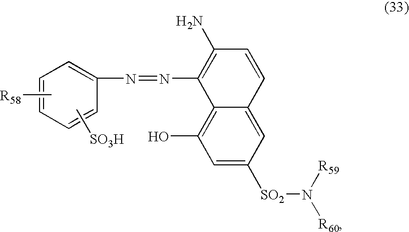

wherein
R₅₈ is hydrogen, C₁-C₄alkyl, C₁-C₄alkoxy, halogen or C₂-C₄alkanoylamino unsubstituted or substituted in the alkyl group by hydroxy, C₁-C₄alkoxy or by halogen;
R₅₉ is phenyl unsubstituted or substituted by C₁-C₄alkyl, C₁-C₄alkoxy, sulfo or by halogen, preferably unsubstituted phenyl, and
R₆₀ is hydrogen or C₁-C₄alkyl; and

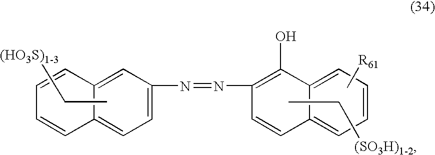

wherein
R₆₁ is a radical of formula

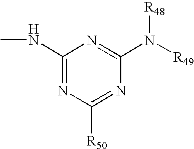

in which R₄₈, R₄₉ and R₅₀ each independently of the others, has the meaning given for formula (29) above;
and disazo dyes of formulae

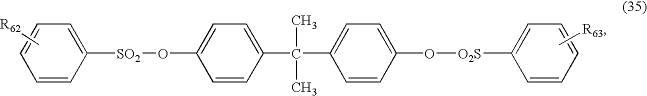

wherein
R₆₂ and R₆₃ are radicals of formula

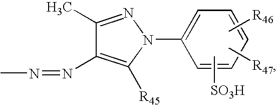

wherein
R₄₅, R₄₆ and R₄₇, each independently of the others, has the meaning given for formula (29) above;

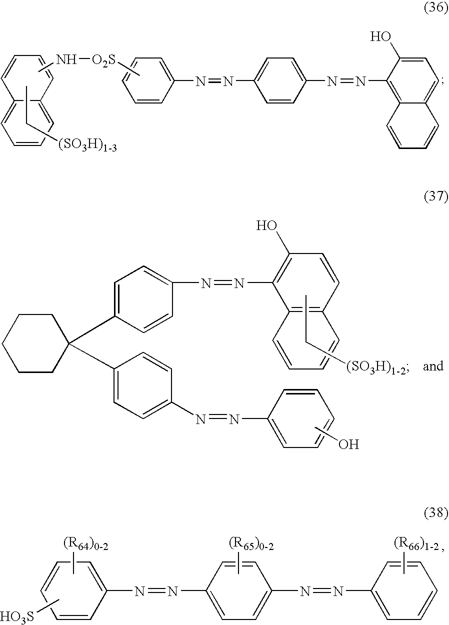

wherein
(R₆₄)₀₋₂ denotes from 0 to 2 identical or different substituents selected from the group C₁-C₄-alkyl and C₁-C₄alkoxy,
(R₆₅)₀₋₂ denotes from 0 to 2 identical or different substituents selected from the group sulfo, C₁-C₄alkyl, C₁-C₄alkoxy, ureido, C₂-C₄alkanoylamino and ureido, and
(R₆₆)₁₋₂ denotes from 0 to 2 identical or different substituents selected from the group sulfo, C₁-C₄alkyl and C₁-C₄alkoxy.

As C₁-C₄alkyl radicals there come into consideration, for example, methyl, ethyl, n-propyl, isopropyl, n-butyl, sec-butyl, tert-butyl and isobutyl, preferably methyl and ethyl.

As C₁-C₆alkyl or C₁-C₈alkyl radicals there come into consideration, for example, methyl, ethyl, n-propyl, isopropyl, n-butyl, sec-butyl, tert-butyl, isobutyl, n-pentyl, sec-pentyl, isopentyl, n-hexyl, n-heptyl and n-octyl.

As C₁-C₄alkoxy radicals there come into consideration, for example, methoxy, ethoxy, n-propoxy, isopropoxy, n-butoxy, sec-butoxy, tert-butoxy and isobutoxy, preferably methoxy and ethoxy, and especially methoxy.

As halogen there come into consideration, for example, fluorine, chlorine, bromine and iodine, preferably chlorine and bromine, and especially chlorine.

As C₂-C₄alkanoylamino radicals there come into consideration, for example, acetylamino and propionylamino, especially acetylamino.

As C₁-C₄alkylsulfonyl radicals there come into consideration, for example, methylsulfonyl, ethylsulfonyl, n-propylsulfonyl, isopropylsulfonyl and n-butylsulfonyl, preferably methylsulfonyl and ethylsulfonyl.

As C₁-C₄alkylaminosulfonyl radicals there come into consideration, for example, methylaminosulfonyl, ethylaminosulfonyl, n-propylaminosulfonyl, isopropylaminosulfonyl and n-butylaminosulfonyl, preferably methylaminosulfonyl and ethylaminosulfonyl.

As C₁-C₄alkoxycarbonylamino radicals there come into consideration, for example, methoxycarbonylamino, ethoxycarbonylamino, n-propoxycarbonylamino, isopropoxycarbonylamino and n-butoxycarbonylamino, preferably methoxycarbonylamino and ethoxycarbonylamino.

As C₁-C₄alkylsulfonylamino radicals there come into consideration, for example, methylsulfonylamino, ethylsulfonylamino, n-propylsulfonylamino, isopropylsulfonylamino and n-butylsulfonylamino, preferably methylsulfonylamino and ethylsulfonylamino.

As C₁-C₄alkoxy-C₁-C₄alkylenaminosulfonyl radicals there come into consideration, for example, methoxy-methyleneaminosulfonyl, methoxy-ethyleneaminosulfonyl, ethoxy-methyleneaminosulfonyl and ethoxy-ethyleneaminosulfonyl, preferably methoxyethyleneaminosulfonyl.

As C₂-C₄hydroxyalkylsulfamoyl radicals there come into consideration, for example β-hydroxyethylsulfamoyl.

As C₅-C₇cycloalkyl radicals there come into consideration, for example, cyclopentyl and cyclohexyl, preferably cyclohexyl.

As C₂-C₄alkanoyl radicals there come into consideration, for example, acetyl and propionyl, preferably acetyl.

In a dedicated embodiment of the present invention the inks comprise dyes of formulae (5), (9), (22), (26), (34) and (35).

Suitable dyes are, for example, the dyes of formulae

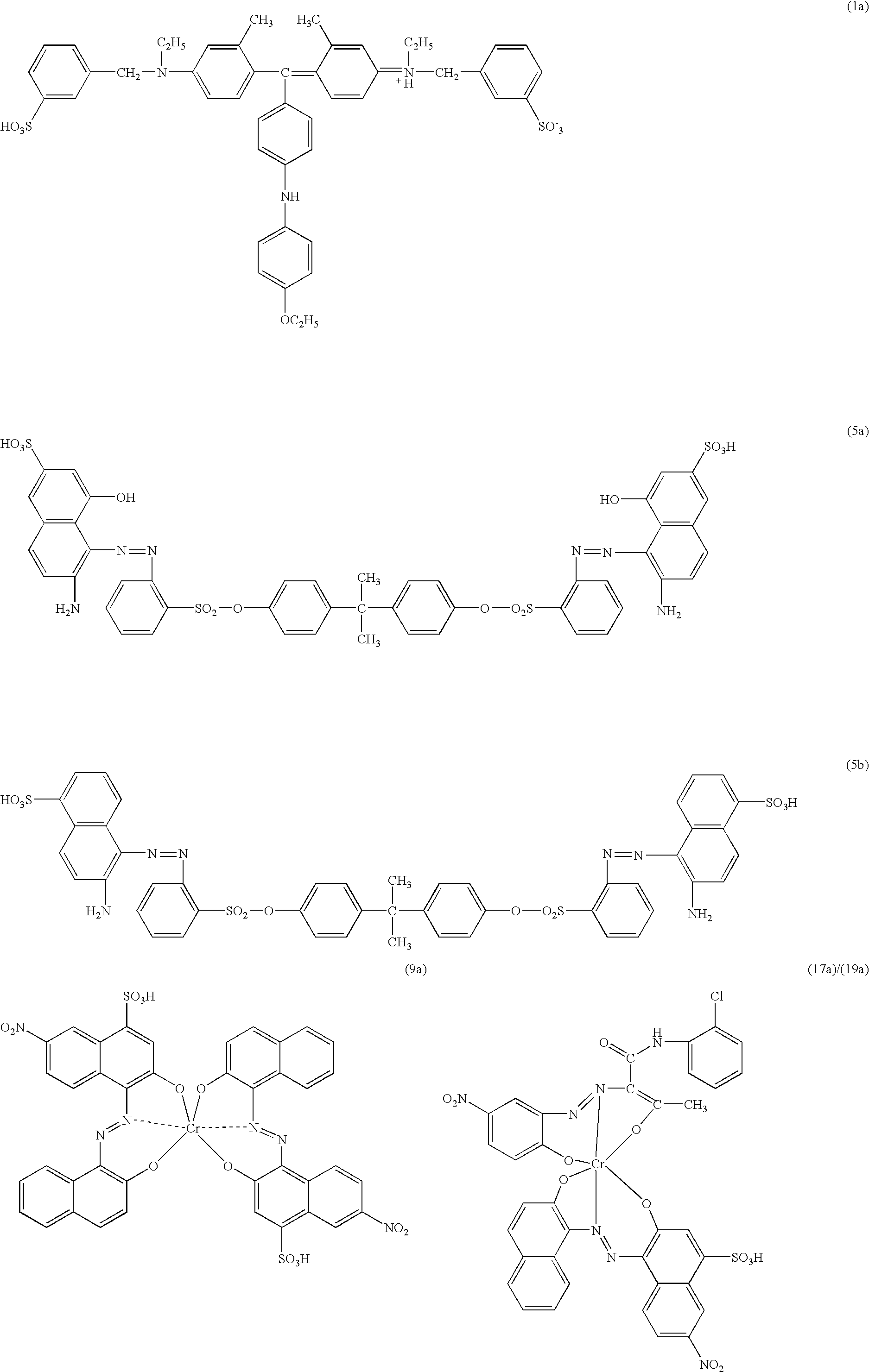

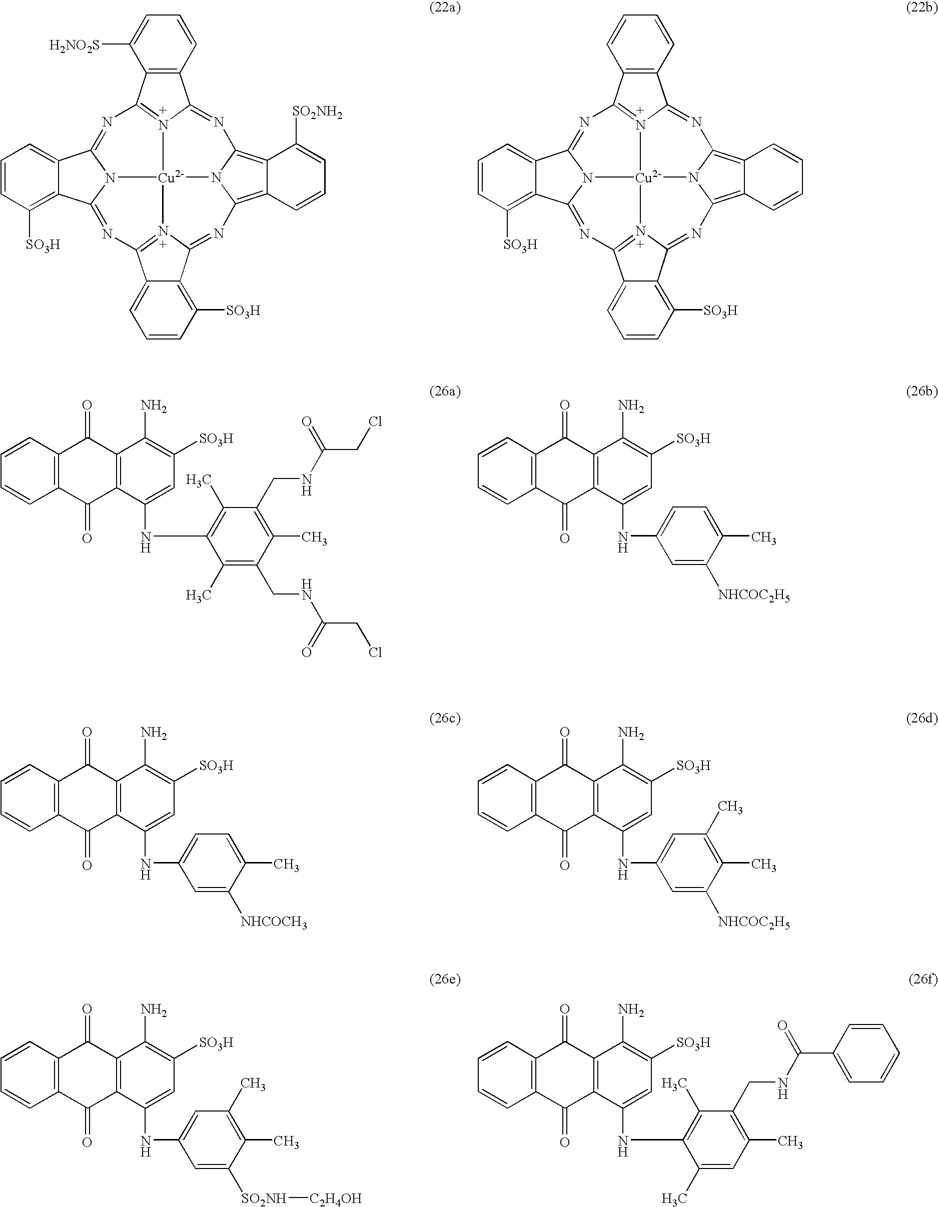

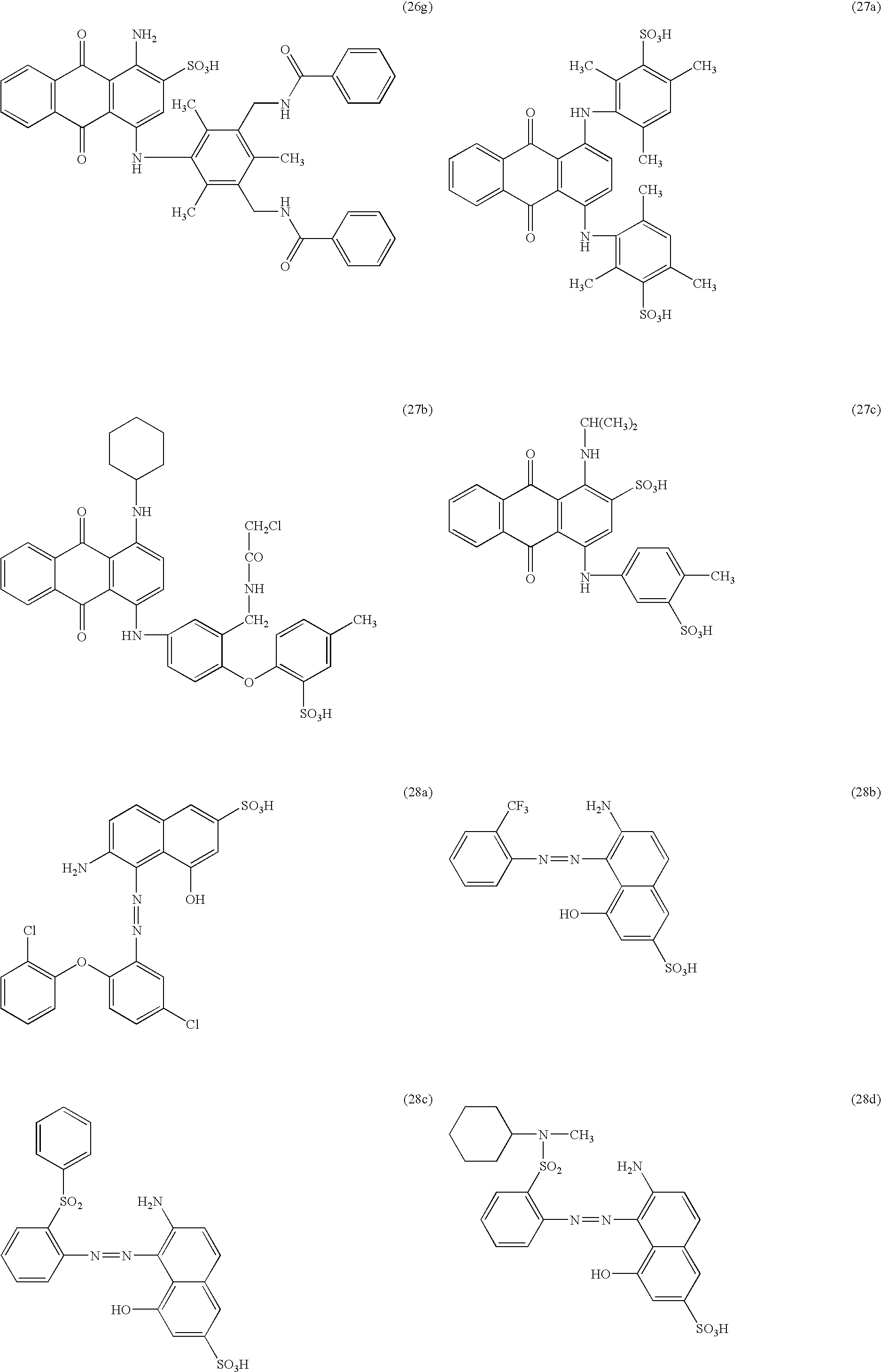

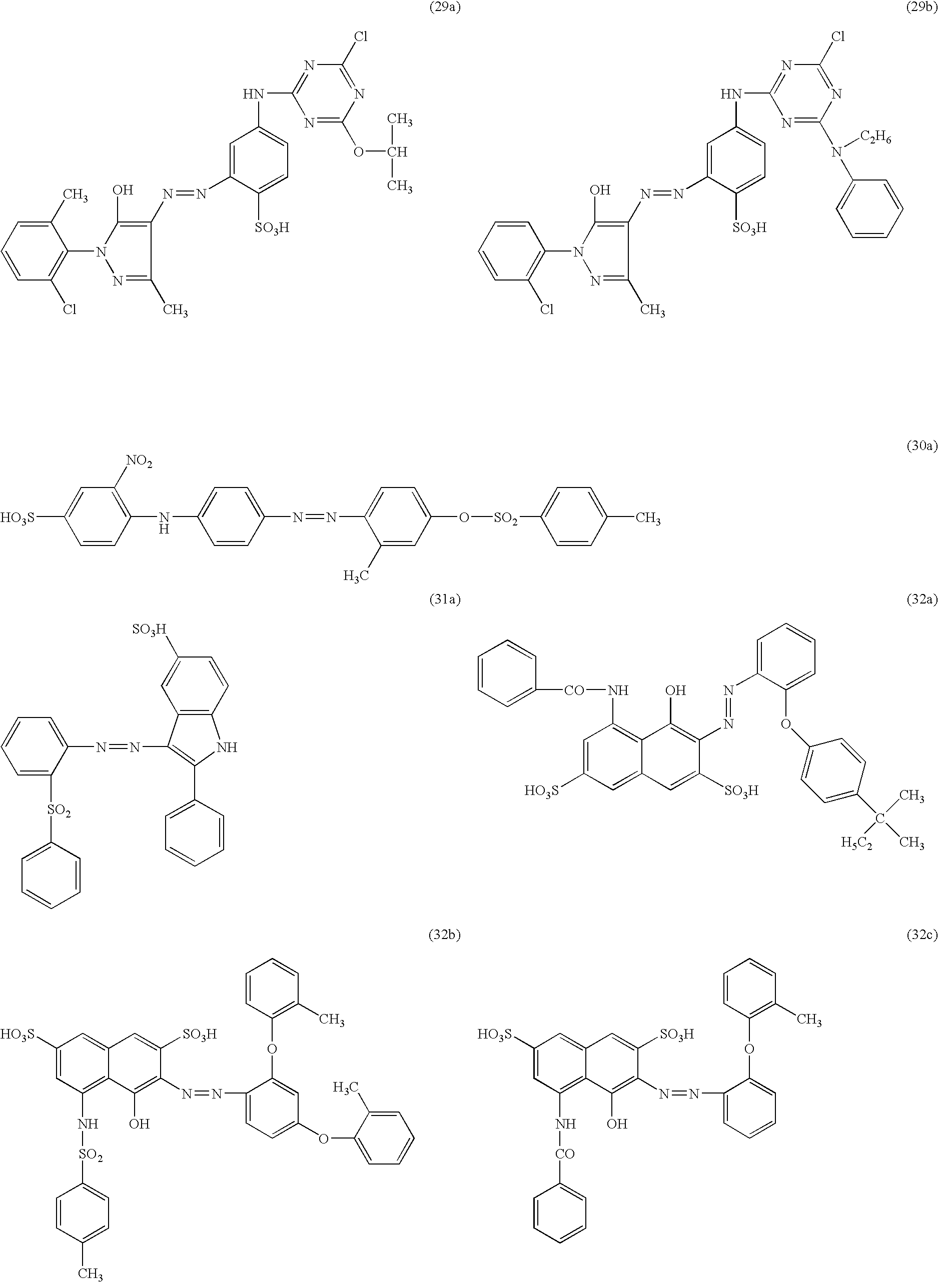

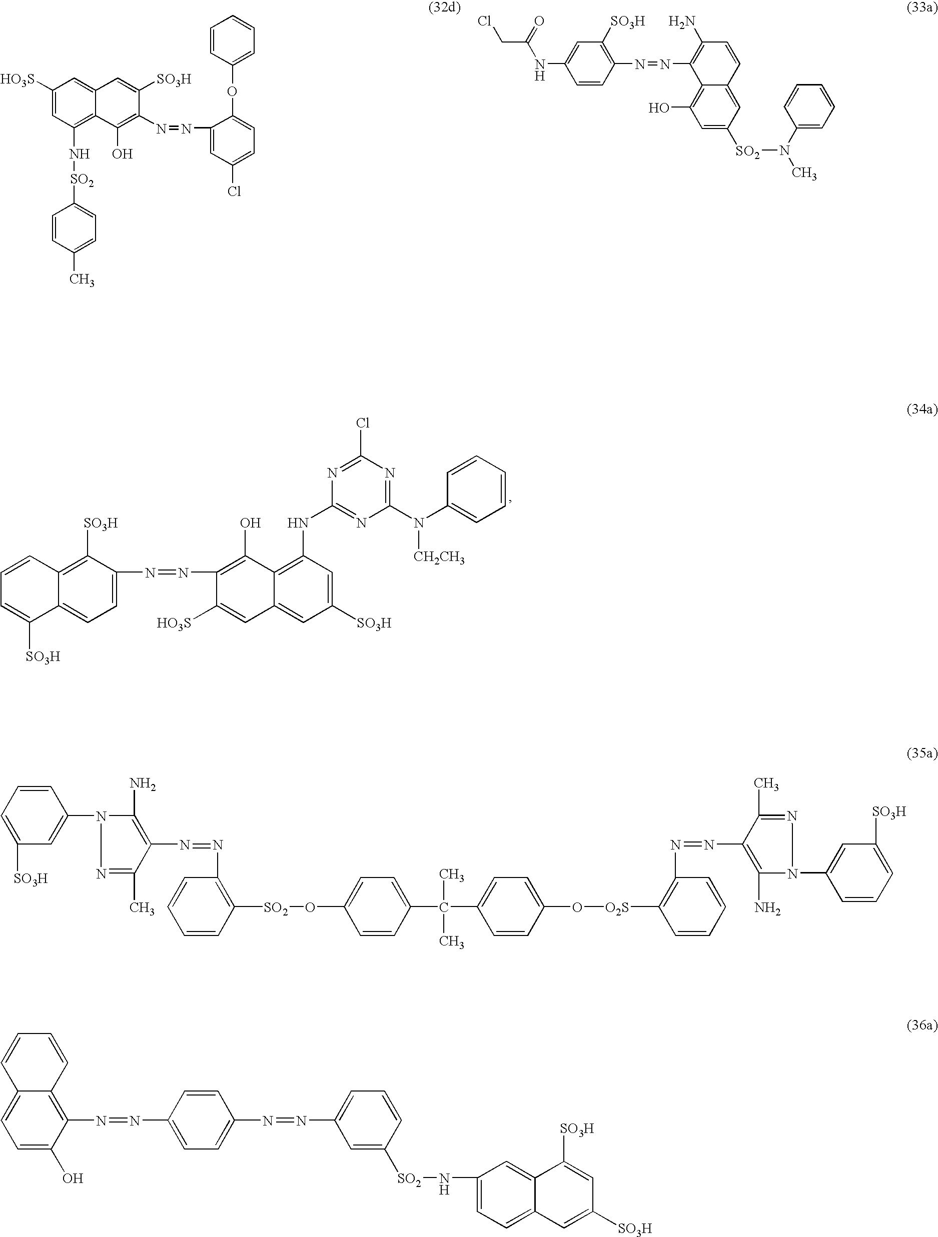

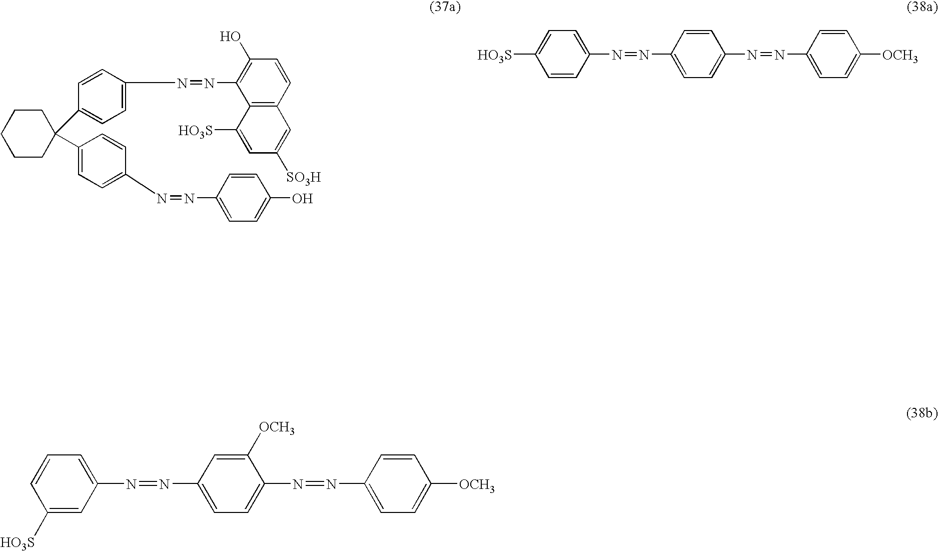

The dyes used in accordance with the present invention may be used as single compounds or as a mixture of two or more dyes.

Preferred are the dyes of formulae (5a), (5b), (9a), (22a), (26b), (26c), (26d), (26e), (26f), (269), (28b), (28d), (30a), (32a), (32b), (32c), (32d), (34a), (35a), (37a), (38a) and (38b), in particular the dyes of formulae (5b), (9a), (22a), (26f), (26g), (34a) and (35a).

The dyes of formulae (1) to (38) are known or can be obtained analogously to known compounds, e.g. by customary diazotisation, coupling, addition and condensation reactions.

The ink applied in accordance with the present invention comprises dipropylene glycol in an amount of, for example, from 5 to 55% by weight, preferably from 5 to 50% by weight, especially from 5 to 45% by weight based on the total weight of the ink. As a lower limit, a limit of 15% by weight, preferably 25% by weight, especially 30% by weight is preferred.

In a preferred embodiment of the present invention the ink comprises dipropylene glycol in an amount of from 25 to 45% by weight, preferably 30 to 45% by weight based on the total weight of the ink.

The inks may also comprise solubilisers, e.g. ε-caprolactam, in an amount of, for example, from 1 to 25% by weight, preferably from 1 to 20% by weight, especially from 1 to 15% by weight based on the total weight of the ink. As a lower limit, a limit of 3% by weight, especially 5% by weight is preferred.

In the indicated embodiment of the present invention the inks may comprise the solubiliser in an amount of from 3 to 15% by weight, preferably 5 to 15% by weight based on the total weight of the ink.

In an interesting embodiment of the present invention the ink comprises dipropylene glycol in an amount of from 25 to 45% by weight and ε-caprolactam in an amount from 5 to 15% by weight, each based on the total weight of the ink.

The inks may comprise thickeners of natural or synthetic origin inter alia for the purpose of adjusting the viscosity.

Examples of thickeners that may be mentioned include commercially available alginate thickeners, starch ethers or locust bean flour ethers, especially sodium alginate on its own or in admixture with modified cellulose, e.g. methylcellulose, ethylcellulose, carboxymethylcellulose, hydroxyethylcellulose, methylhydroxyethylcellulose, hydroxypropyl cellulose or hydroxypropyl methylcellulose, especially with preferably from 20 to 25% by weight carboxymethylcellulose. Synthetic thickeners that may be mentioned are, for example, those based on poly(meth)acrylic acids, poly(meth)acrylamides or polyvinyl pyrrolidones.

The inks comprise such thickeners in an amount of, for example, from 0.01 to 2% by weight, especially from 0.05 to 1.2% by weight and more especially from 0.1 to 1% by weight, based on the total weight of the ink.

With or without such viscosity adjusting agent, the viscosity of the ink is adjusted to be from 6 to 14 mPa·s at 25° C., especially from 7 to 12 mPa s at 25° C. and more especially from 8 to 10 mPa s at 25° C.

Unless otherwise indicated, numbers expressing the viscosity of the inks applied in accordance with the present invention are measured with a Brookfield DV-II viscosimeter.

In an interesting embodiment of the present invention poly C₂-C₄-alkyleneglycol or the mono- or di-C₁-C₄-alkyl ether of poly C₂-C₄-alkyleneglycol may be used as a viscosity adjusting agent, the alkylene moieties of which may be straight chained or branched, especially poly C₂-C₃-alkyleneglycol, such as, polyethylene glycol, polypropylene glycol or a mixed ethylene oxide/propylene oxide copolymerisate, and more especially a mixed ethylene oxide/propylene oxide copolymerisate. The molar mass is, for example, from 1,000 to 35,000 g/mol, preferably from 2,000 to 25,000 g/mol and especially from 3,000 to 20,000. The said compounds are commercially available, for example, as P41-type polyglycols (Clariant).

Dipropylene glycol is used solely, although alternatively, a mixture of two or more organic solvents may be used. Further organic solvents which may be used in combination with dipropylene glycol are water-miscible organic solvents, for example C₁-C₄-alcohols, such as methanol, ethanol, n-propanol, isopropanol, n-butanol, sec-butanol, tert-butanol and iso-butanol; amides, e.g. dimethylformamide and dimethylacetamide; ketones or ketone alcohols, e.g. acetone and diacetone alcohol; ethers, e.g. tetrahydrofuran and dioxane; nitrogen-containing heterocyclic compounds, e.g. N-methyl-2-pyrrolidone and 1,3-dimethyl-2-imidazolidone; further glycols or thioglycols, e.g. ethylene glycol, 1,2-propylene glycol, butylene glycol, thiodiglycol and hexylene glycol; further polyols, e.g. glycerol, 1,2,6-hexanetriol; and C₁-C₄alkyl ethers of polyhydric alcohols, e.g. 2-methoxyethanol, 2-(2-methoxyethoxy)ethanol, 2-(2-ethoxyethoxy)ethanol, 2-[2-(2-methoxyethoxy)ethoxy]-ethanol and 2-[2-(2-ethoxyethoxy)ethoxy]ethanol.

Preferably, dipropylene glycol is used solely without any further organic solvent being added.

The inks may also comprise buffer substances, e.g. borax, borates, phosphates, polyphosphates or citrates. Examples that may be mentioned include borax, sodium borate, sodium tetraborate, sodium dihydrogen phosphate, disodium hydrogen phosphate, sodium tripolyphosphate, sodium pentapolyphosphate and sodium citrate. They are used especially in amounts of from 0.1 to 3% by weight, preferably from 0.1 to 1% by weight, based on the total weight of the ink, in order to establish a pH value, for example, from 4 to 10, especially from 5 to 9.5 and more especially from 8 to 9.

In addition to the components mentioned above, the inks in accordance with the Inventive process may contain, as required, various additives such as surfactants, humectants, viscosity adjusting agents, buffers, antifoam agents, or preservatives, substances that inhibit the growth of fungi and/or bacteria, etc.

Suitable surfactants include commercially available anionic or non-ionic surfactants. As humectants in the inks according to the invention there come into consideration, for example, urea or sodium lactate (advantageously in the form of a 50% to 60% aqueous solution), and polyethylene glycols having a molecular weight of preferably from 200 to 800, e.g. polyethylene glycol 200.

As preservatives there come into consideration formaldehyde-releasing agents, e.g. paraformaldehyde and trioxane, especially aqueous, for example 30 to 40% by weight formaldehyde solutions, imidazole compounds, e.g. 2-(4-thiazolyl)benzimidazole, thiazole compounds, e.g. 1,2-benzisothiazolin-3-one or 2-n-octyl-isothiazolin-3-one, iodine compounds, nitriles, phenols, haloalkylthio compounds and pyridine derivatives, especially 1,2-benzisothiazolin-3-one or 2-n-octyl-isothiazolin-3-one. As an example for a broad spectrum biocide for the preservation against spoilage from bacteria, yeasts and fungi a 20% by weight solution of 1,2-benzisothiazolin-3one in dipropylene glycol (Proxel™ GXL) can be used.

The inks may comprise further ingredients, such as fluorinated polymers or telomers, for example, polyethoxy perfluoro alcohols (Forafac® or Zonyl® products) in an amount of, for example, from 0.005 to 1% by weight based on the total weight of the ink.

It is preferred that the surface tension is adjusted to range from 20 to 40 dyne/cm at 25° C. and especially from 25 to 35 dyne/cm at 25° C.

Furthermore it is preferred that the conductivity of the ink is adjusted to range from 1 to 6 mS/cm at 25° C. and especially from 1 to 4 mS/cm at 25° C.

The inks can be prepared in customary manner by mixing the individual constituents together in the desired amount of water.

It has been found that the inks described above can be advantageously applied to the textile fiber materials by means of an ink-jet printing device provided with at least one ink-jet print head which comprises
a nozzle layer (a) defining a plurality of ejection nozzles,
an ink supply layer (b) which is formed from a porous material having a multitude of small interconnected pores so as to allow passage of ink therethrough, the ink supply layer featuring a plurality of connecting bores (holes) from the rear surface to the front surface, each connecting bore being aligned so as to connect between a corresponding one of the ejection nozzles and
a deflection layer (c), comprising a plurality of transducers related to the connecting bores for ejecting ink droplets out through the nozzles.

The ink-jet print head applied in accordance with the present invention may additionally comprise
an ink cavity layer (d), associated with the rear surface of the ink supply layer (b) having a plurality of apertures, each aperture being positioned to correspond to one of the connecting bores of the ink supply layer so as to at least partially define a corresponding ink cavity.

The ink-jet print head applied in accordance with the present invention comprises a layered structure, a key element of which is the ink supply layer (b) made of a porous material. The ink supply layer (b) is in direct communication with both the ink reservoir and the individual ink cavities of the connecting bores (holes) and/or the individual ink cavities of the ink cavity layer (d), thereby acting as hydraulic linkage between the ink main supply and the individual ink cavities.

The porous material includes, for example, sintered material, most preferably, sintered stainless steel.

The ink cavity layer (d) may be omitted. In this case, the deflection layer directly adjoins the ink supply layer.

The ink-jet print head used in accordance with the present invention is described in detail in U.S. Pat. No. 5,940,099, the disclosure of which is incorporated herein.

The ink-jet print head applied in accordance with the present invention belongs to the category of drop on demand systems, wherein the ink drops are ejected selectively as required.

The transducers are, for example, piezoelectric crystals (piezoelectric type) or thermoelectric elements (thermal bubble jet type), preferably piezoelectric crystals.

The ejection of ink drops using a device according to one embodiment of the present invention is accomplished as follows:

A pressure pulse is imparted to a volume of ink in an ink cavity through the deflection of a thin deflection plate, or diaphragm, located on top of the ink cavity. The plate is deflected downward by the action of a piezoceramic crystal whenever a voltage is applied across its electrodes, one of which is in electrical contact with the usually metallic deflection plate. The pressure pulse created by the downward bending of the deflection plate drives the ink towards and through an outlet, having a convergent nozzle at its outlet end, causing the ejection of a drop of a specific size. When the piezoelectric crystal is de-energized, it returns to its equilibrium position, reducing the pressure in the ink cavity and causing the meniscus at the outlet end to retract. The retracted meniscus generates a capillary force which acts to pull ink from an ink reservoir through the porous material of the ink supply layer (b) into the ink cavity and into the connecting bores (holes) related to the nozzle. The refilling process ends when the meniscus regains its equilibrium position.

The micron grade and the surface area of the porous material which is open for flow into the ink cavity has a crucial impact on the refill time of the ink cavities and hence on the maximum drop ejection rate, or frequency. The ink according to the inventive process moves through the interconnected pores and channels of the ink supply layer (b) with suitable flow resistances in order to realize system performance which allows for high ejection frequencies, for example, 5 to 100 kHz, preferably 10 to 50 kHz and especially 25 to 40 kHz. Moreover the inks cause no clogging of the ejection nozzles. Feathering or blurring and blotting on the cloth is omitted. The inks are storage stable, i.e. no deposition of solid matter is observed in the course of storage.

Further embodiments of suitable ink-jet print head configurations comprising an ink supply layer which is formed from a porous material are described in U.S. Pat. No. 5,940,099, all of which can be used in the process according to the present invention.

In a preferred embodiment of the present invention the ink-jet print head comprises
a nozzle layer (a) defining a plurality of ejection nozzles,
an ink supply layer (b) having a front surface associated with the nozzle layer and a rear surface associated with a cavity layer (d), the ink supply layer being formed with a plurality of connecting bores (holes) from the rear surface to the front surface, each connecting bore being aligned so as to connect between a corresponding one of the ink cavities and a corresponding one of the ejection nozzles, wherein the ink supply layer additionally features (i) a pattern of ink distribution channels formed in the front surface, and (ii) at least one ink inlet bore passing from the rear surface to the front surface and configured so as to be in direct fluid communication with at least part of the pattern of ink distribution channels, the pattern of ink distribution channels and the at least one ink inlet bore together defining part of an ink flow path which passes from the rear surface through the at least one ink inlet bore to the pattern of ink distribution channels on the front surface, and through the porous material to the plurality of ink cavities.
a deflection layer (c), comprising a plurality of transducers related to the connecting bores for ejecting ink droplets out through the nozzles.

The location of ink distribution channels on the front surface ensures that ink flow through the porous material of ink supply layer occurs through the bulk of the layer. Preferably ink distribution channels are distributed over the front surface in such a pattern that each connecting bore is approximately the same distance from its nearest ink distribution channel. In the typical case that the connecting bores define an array on the front surface having two row directions, the pattern of ink distribution channels preferably includes a plurality of channels deployed substantially parallel to one of the row directions and interposed between adjacent rows of the connecting bores. The ink flow path is particularly effective for providing a sufficient and generally uniform ink supply to the porous layer across an entire array of ink cavities.

The ink-jet print head used in accordance with the present invention is a multi-nozzle print head, the individual nozzles of which are advantageously arranged as an array made up of horizontal rows which are horizontally staggered, or skewed, with respect to one another, comprising, for example, 512 nozzles staggered in a 32×16 array.

The ink-jet print head used in accordance with the preferred embodiment of the present invention is described in detail in U.S. Pat. No. 6,439,702, the disclosure of which is incorporated herein.

Further embodiments of suitable ink-jet print head configurations comprising an ink supply layer which is formed from a porous material are described in U.S. Pat. No. 6,439,702, all of which can be used in the process according to the present invention.

The ink-jet printing device used in accordance with the present invention comprises at least one of the ink-jet print heads described above. Preferably, the printing device uses at least 3 process colors, for example 3, 4, 5 or 6 process colors, preferably 6 process colors, wherein each color is processed with at least one print head, for example 1, 2, 3, 4, 5, 6 or 7 printing heads, preferably 7 printing heads.

The present invention allows textile fiber materials to be printed with a speed of at least 50 m²/h, preferably in the range of 100 to 250 m²/h, especially 150 to 250 m²/h.

Fibrous textile materials that come into consideration are especially nitrogen-containing or hydroxyl-group-containing fibrous materials. As nitrogen-containing fibrous materials there come into consideration natural or synthetic polyamide materials, e.g. fibrous textile materials of silk, wool or synthetic polyamides. Synthetic fibrous polyamide materials are, for example, fibrous polyamide-6 and polyamide-66 materials.

The process according to the invention is used especially preferably to print silk or silk-containing mixed fibrous material. As silk there come into consideration not only natural silk and cultured silk (mulberry silk, Bombyx mori) but also the various wild silks, especially tussah silk, and also eria and fagar silks, slub silk, Senegal silk, muga silk, and also mussel silk and spider silk. Silk-containing fibrous materials are especially blends of silk with polyester fibres, acrylic fibres, cellulose fibres, polyamide fibres or with wool. The said textile material can be in a wide variety of processing forms, e.g. in the form of woven or knitted fabrics.

For printing silk or silk-containing fibrous material, the fibrous material is preferably subjected to a pretreatment. To that end the fibrous material is pretreated with an aqueous liquor comprising a thickener and, where appropriate, a hydrotropic agent. The thickeners preferably employed are alginate thickeners, such as commercially available sodium alginate thickeners, which are used, for example, in an amount of from 50 to 200 g/l of liquor, preferably from 100 to 200 g/l of liquor. The hydrotropic agent preferably employed is urea, which is used, for example, in an amount of from 25 to 200 g/l of liquor, preferably from 25 to 75 g/l of liquor. The liquor may in addition comprise further ingredients, e.g. ammonium tartrate. The liquor is preferably applied to the fibrous material according to the pad-dyeing method, especially with a liquor pick-up of from 70 to 100%. Preferably, the fibrous material is dried after the above pretreatment.

After printing, the fibre material is advantageously dried, preferably at temperatures of up to 150° C., especially from 80 to 120° C., and then, where necessary, subjected to a heat treatment process in order to complete the print, that is to say to fix the dye.

The heat treatment can be carried out, for example, by means of a hot batch process, a thermosol process or, preferably, by means of a steaming process.

In the case of the steaming process the printed fibre material is subjected, for example, to treatment in a steamer with steam which is optionally superheated, advantageously at a temperature of from 95 to 180° C., more especially in saturated steam.

Subsequently the printed fibre material is generally washed off with water in customary manner in order to remove unfixed dye.

Using the printing processes indicated above it is possible to print fibrous materials either in a single shade or in a variety of shades. When the printing is in one shade, the fibrous material can be printed over the entire surface or with a pattern. The use of a single ink is, of course, sufficient for that purpose, but the desired shade can also be created by printing with a plurality of inks of different shades. When the fibrous material is to receive a print having a plurality of different shades, the fibrous material can either be printed with a plurality of inks that each have the desired shade or printed in such a manner that the shade in question is created (for example by printing the fibrous material with inks of different shades one on top of another, thus producing the required shade).

The prints produced are distinguished especially by a high tinctorial strength and a high color brilliance as well as by good light-fastness and wet-fastness properties.

The present invention relates also to an aqueous inks comprising

(I) at least one anionic acid dye, and
(II) dipropylene glycol,
said ink having a viscosity of from 5 to 20 mPa s at 25° C., wherein
the variables associated with components (I) and (II) have the meanings and preferences given above.

The inks according to the present invention may be used in an ink-jet printing process for printing on different kinds of substrates, such as paper, films of plastic or textile fiber materials. In particular the inks are used in the process according to the present invention.

The following Examples serve to illustrate the invention. Unless otherwise indicated, the temperatures are given in degrees Celsius, parts are parts by weight and percentages relate to percent by weight. Parts by weight relate to parts by volume in a ratio of kilograms to litres.

### EXAMPLE 1

a) A silk fabric web is padded with an aqueous liquor (liquor pick-up 90%) containing 150 g/l of a commercially available alginate thickener, 50 g/l of urea and 50 g/l of an aqueous ammonium tartrate solution (25%) and dried.

b) The silk fabric pretreated in accordance with step a) is printed with an industrial piezoelectric drop on demand ink-jet printing device (Reggiani DReAM) at a speed of 150 m²/h. The device processes 6 colors (6 inks), wherein each process color is printed with 7 print heads (Aprion).

The inks are as follows:

a yellow aqueous ink containing:
8.0% by weight of the dye of formula (35a),
5.0% by weight of ε-caprolactam,
35.0% by weight of dipropylene glycol,
0.3% by weight of a commercial preservative,
51.7% by weight of water;
   an orange aqueous ink containing:
8.0% by weight of the dye of formula (5b),
40.0% by weight of dipropylene glycol,
0.3% by weight of a commercial preservative,
51.7% by weight of water;
   a red aqueous ink containing:
9.0% by weight of the dye of formula (34a),
40.0% by weight of dipropylene glycol,
0.3% by weight of a commercial preservative,
50.7% by weight of water;
   a blue aqueous ink containing:
8.0% by weight of a mixture of the dyes of formulae (26f) and (26g),
10.0% by weight of ε-caprolactam,
30.0% by weight of dipropylene glycol,
0.3% by weight of a commercial preservative,
51.7% by weight of water;
   a turquoise aqueous ink containing:
8.0% by weight of the dye of formula (22a),
40.0% by weight of dipropylene glycol,
0.3% by weight of a commercial preservative,
51.7% by weight of water;
   a black aqueous ink containing:
10.0% by weight of the dye of formula (9a),
10.0% by weight of ε-caprolactam,
30.0% by weight of dipropylene glycol,
0.3% by weight of a commercial preservative,
49.7% by weight of water;

The print is dried on line with an integrated hot air dryer at 100° C., fixed in saturated steam at 102° C. and is then washed off. A brillant multicolour print having good fastness properties is obtained.

### EXAMPLE 2

a) A silk fabric web is padded with an aqueous liquor (liquor pick-up 90%) containing 270 g/l of a commercially available low-molecular-weight alginate thickener, 150 g/l of urea and 50 g/l of an aqueous ammonium tartrate solution (25%) and dried.

b) The silk fabric pretreated in accordance with step a) is printed with an industrial piezoelectric drop on demand ink-jet printing device (Reggiani DReAM) at a speed of 150 m²/h in analogy to the process of Example 1 using the inks according to Example 1. The print is dried on line with an integrated hot air dryer at 100° C., fixed in saturated steam at 102° C. and is then washed off. A brillant multicolour print having good fastness properties is obtained.

### EXAMPLE 3

The inks according to Example 1 are used to print a polyamide fabric web with an industrial piezoelectric drop on demand ink-jet printing device (Reggiani DReAM) at a speed of 150 m²/h. The print is dried on line with an integrated hot air dryer at 100° C., fixed in saturated steam at 102° C. and is then washed off. A brillant multicolour print having good fastness properties is obtained.

### EXAMPLE 4

The inks according to Example 1 are used to print a wool fabric web with an industrial piezoelectric drop on demand ink-jet printing device (Reggiani DReAM) at a speed of 150 m²/h. The print is dried on line with an integrated hot air dryer at 100° C., fixed in saturated steam at 102° C. and is then washed off. A brillant multicolour print having good fastness properties is obtained.

### EXAMPLE 5

Example 1 is repeated, but using in place of the orange ink given in Example 1 an orange aqueous ink containing:
8.0% by weight of the dye of formula (5a),
40.0% by weight of dipropylene glycol,
0.3% by weight of a commercial preservative,
51.7% by weight of water.

### EXAMPLE 6

a) A silk fabric web is padded with an aqueous liquor (liquor pick-up 90%) containing 150 g/l of a commercially available alginate thickener, 50 g/l of urea and 50 g/l of an aqueous ammonium tartrate solution (25%) and dried.

b) The silk fabric pretreated in accordance with step a) is printed with an industrial piezoelectric drop on demand ink-jet printing device (Reggiani DReAM) at a speed of 150 m²/h. The device processes 6 colors (6 inks), wherein each process color is printed with 7 print heads (Aprion).

a yellow aqueous ink containing:
8.0% by weight of the dye of formula (35a),
5.0% by weight of ε-caprolactam,
35.0% by weight of dipropylene glycol,
0.3% by weight of a commercial preservative,
51.7% by weight of water;
   a red aqueous ink containing:
9.0% by weight of the dye of formula (34a),
40.0% by weight of dipropylene glycol,
0.3% by weight of a commercial preservative,
50.7% by weight of water;
   a red aqueous ink containing:
1.8% by weight of the dye of formula (34a),
40.0% by weight of dipropylene glycol,
0.3% by weight of a commercial preservative,
57.9% by weight of water;
   a turquoise aqueous ink containing:
8.0% by weight of the dye of formula (22a),
40.0% by weight of dipropylene glycol,
0.3% by weight of a commercial preservative,
51.7% by weight of water;
   a turquoise aqueous ink containing:
1.6% by weight of the dye of formula (22a),
40.0% by weight of dipropylene glycol,
0.3% by weight of a commercial preservative,
58.1% by weight of water;
   a black aqueous ink containing:
10.0% by weight of the dye of formula (9a),
10.0% by weight of ε-caprolactam,
30.0% by weight of dipropylene glycol,
0.3% by weight of a commercial preservative,
49.7% by weight of water;

The print is dried on line with an integrated hot air dryer at 100° C., fixed in saturated steam at 102° C. and is then washed off. A brillant multicolour print having good fastness properties is obtained.

1. An ink-jet printing process for printing textile fibre materials, wherein:
the fiber materials are printed with an aqueous ink comprising
(I) at least one anionic acid dye, and
(II) dipropylene glycol,
said ink having a viscosity of from 5 to 20 mPa s at 25° C., and wherein
said ink is applied to the fiber material with an ink-jet print head comprising
an ink supply layer (b) receiving ink from an external ink reservoir, said ink supply layer having a first side and a second side and comprising, a porous medium having a plurality of pores therein and a plurality of holes extending therethrough, so as to allow passage of the ink.

2. A process according to claim 1, wherein
the aqueous ink comprises as the anionic acid dye:
disazo dyes of formula 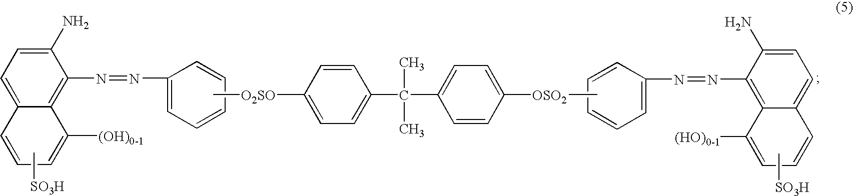
1:2 metal complex dyes of formula 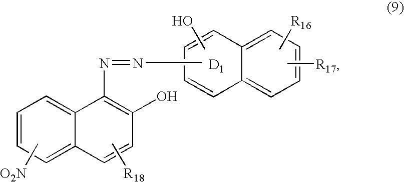
wherein
R₁₆ is hydrogen, C₁-C₄alkoxycarbonylamino, benzoylamino, C₁-C₄alkylsulfonylamino, phenylsulfonylamino, methylphenylsulfonylamino or halogen,
R₁₇ is hydrogen or halogen, and
R₁₈ is C₁-C₄alkylsulfonyl, C₁-C₄alkylaminosulfonyl, phenylazo, sulfo or —SO₂NH₂, the hydroxy group in the benzo ring D₁ being bound in the o-position relative to the azo group on the benzo ring D₁;
the copper complex of formula 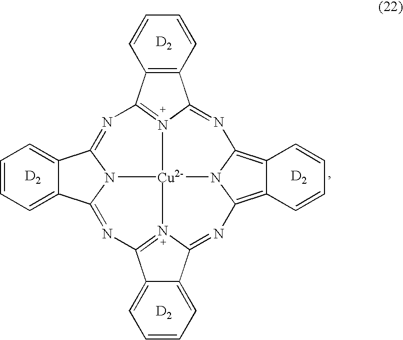
wherein
the benzo rings D₂ are substituted by sulfo or by sulfonamido;
metal-free anionic anthraquinone dyes of formula 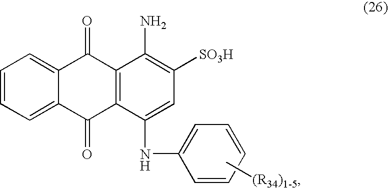
wherein
(R₃₄)₁₋₅ denotes from 1 to 5 identical or different substituents selected from the group C₁-C₄-alkyl unsubstituted or substituted by C₂-C₄alkanoylamino (which may in turn be substituted in the alkyl group by halogen) or by benzoylamino; C₁-C₄alkoxy; C₂-C₄alkanoylamino and C₂-C₄hydroxyalkylsulfamoyl;
monoazo dyes of formula 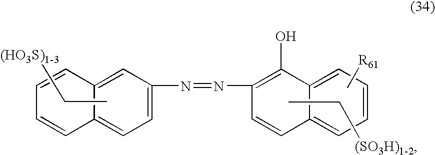
wherein
R₆₁ is a radical of formula 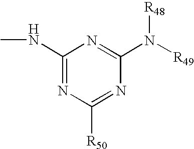
in which R₄₈ is phenyl unsubstituted or substituted by C₁-C₄alkyl, C₁-C₄alkoxy, halogen or by sulfo, R₄₉ is hydrogen or C₁-C₄alkyl and R₅₀ is halogen; and
disazo dyes of formula 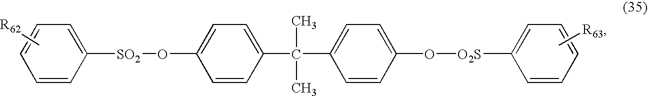
wherein
R₆₂ and R₆₃ are radicals of formula 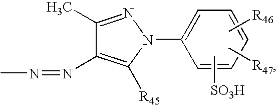
wherein
R₄₅ is hydroxy or amino; and
R₄₆ and R₄₇ are each independently of the other hydrogen, C₁-C₄alkyl or halogen.

3. A process according to claim 1, wherein
the viscosity of the ink is from 6 to 14 mPa·s at 25° C.

4. A process according to claim 1, wherein dipropylene glycol is used in an amount of from 25 to 45% by weight based on the total weight of the ink.

5. A process according to claim 1, wherein ε-caprolactam is used in an amount of from 3 to 15% by weight based on the total weight of the ink.

6. A process according to claim 1, wherein printing is performed by means of an ink-jet printing device provided with at least one ink-jet print head which comprises
a nozzle layer (a) defining a plurality of ejection nozzles,
an ink supply layer (b) which is formed from a porous material having a multitude of small interconnected pores so as to allow passage of ink therethrough, said ink supply layer featuring a plurality of connecting bores from the rear surface to the front surface, each of said connecting bore being aligned so as to connect between a corresponding one of said ejection nozzles and
a deflection layer (c), comprising a plurality of transducers related to said connecting bores for ejecting ink droplets out through the nozzles.

7. A process according to claim 1, wherein printing is performed by means of an ink-jet printing device provided with at least one ink-jet print head which comprises
a nozzle layer (a) defining a plurality of ejection nozzles,
an ink supply layer (b) having a front surface associated with the nozzle layer and a rear surface associated with a cavity layer (d), said ink supply layer being formed with a plurality of connecting bores from said rear surface to said front surface, each connecting bore being aligned so as to connect between a corresponding one of said ink cavities and a corresponding one of said ejection nozzles, wherein said ink supply layer additionally features
(i) a pattern of ink distribution channels formed in said front surface, and
(ii) at least one ink inlet bore passing from said rear surface to said front surface and configured so as to be in direct fluid communication with at least part of said pattern of ink distribution channels, said pattern of ink distribution channels and said at least one ink inlet bore together defining part of an ink flow path which passes from said rear surface through said at least one ink inlet bore to said pattern of ink distribution channels on said front surface, and through said porous material to said plurality of ink cavities,
a deflection layer (c), comprising a plurality of transducers related to said connecting bores for ejecting ink droplets out through the nozzles.

8. A process according to claim 1, wherein the transducer is a piezoelectric element.

9. A process according to claim 1, wherein nitrogen-containing or hydroxyl-group-containing fibrous materials, are printed.

10. An aqueous printing ink for the ink-jet printing process, comprising
(I) at least one anionic acid dye, and
(II) dipropylene glycol,
said ink having a viscosity of from 5 to 20 mPa s at 25° C., wherein
the aqueous ink comprises as the anionic acid dye:
disazo dyes of formula 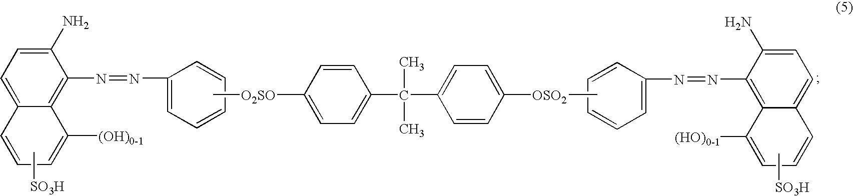
1:2 metal complex dyes of formula 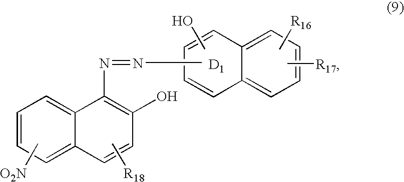
wherein
R₁₆ is hydrogen, C₁-C₄alkoxycarbonylamino, benzoylamino, C₁-C₄alkylsulfonylamino, phenylsulfonylamino, methylphenylsulfonylamino or halogen,
R₁₇ is hydrogen or halogen, and
R₁₈ is C₁-C₄alkylsulfonyl, C₁-C₄alkylaminosulfonyl, phenylazo, sulfo or —SO₂NH₂, the hydroxy group in the benzo ring D₁ being bound in the o-position relative to the azo group on the benzo ring D₁;
the copper complex of formula 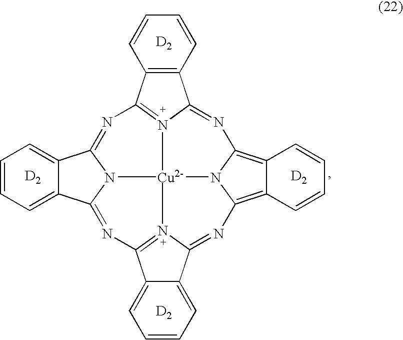
wherein
the benzo rings D₂ are substituted by sulfo or by sulfonamido;
metal-free anionic anthraquinone dyes of formula 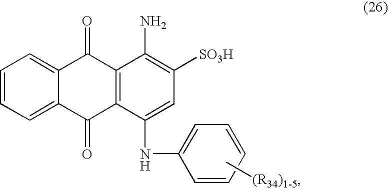
wherein
(R₃₄)₁₋₅ denotes from 1 to 5 identical or different substituents selected from the group C₁-C₄-alkyl unsubstituted or substituted by C₂-C₄alkanoylamino (which may in turn be substituted in the alkyl group by halogen) or by benzoylamino; C₁-C₄alkoxy; C₂-C₄alkanoylamino and C₂-C₄hydroxyalkylsulfamoyl;
monoazo dyes of formula 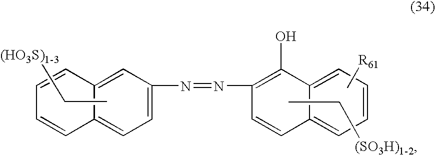
wherein
R₆₁ is a radical of formula 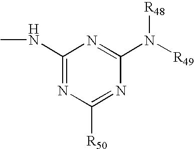
in which R₄₈ is phenyl unsubstituted or substituted by C₁-C₄alkyl, C₁-C₄alkoxy, halogen or by sulfo, R₄₉ is hydrogen or C₁-C₄alkyl and R₅₀ is halogen; and
disazo dyes of formula 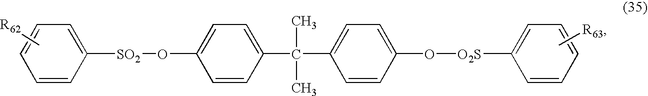
wherein
R₆₂ and R₆₃ are radicals of formula 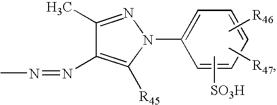
wherein
R₄₅ is hydroxy or amino; and
R₄₆ and R₄₇ are each independently of the other hydrogen, C₁-C₄alkyl or halogen, and said ink has a viscosity of from 5 to 20 mPa s at 25° C.

11. A process according to claim 1, wherein
the viscosity of the ink is from 8 to 10 mPa·s at 25° C.

12. A process according to claim 1, wherein
dipropylene glycol is used in an amount of from 30 to 45% by weight based on the total weight of the ink.

13. A process according to claim 1, wherein
ε-caprolactam is used in an amount of from 5 to 15% by weight based on the total weight of the ink.

14. A process according to claim 1, wherein natural or synthetic polyamide fiber materials are printed.
